(19) United States
(12) Patent Application Publication
(10) Pub. No.: US 2015/0374117 A1
(43) Pub. Date: Dec. 31, 2015

(54) Holder Assembly for Portable Electronic Devices

(71) Applicants: Marco Lozano, Yuma, AZ (US); Kimberly Lozano, Yuma, AZ (US)

(72) Inventors: Marco Lozano, Yuma, AZ (US); Kimberly Lozano, Yuma, AZ (US)

(21) Appl. No.: 14/317,786

(22) Filed: Jun. 27, 2014

(51) Int. Cl. A47B 19/06; A47B 23/00; H02J 7/00; F16M 11/20; F16M 11/06; F16M 11/28; F16M 13/02

(52) U.S. Cl. CPC A47B 19/06; F16M 11/28; A47B 23/00; F16M 13/022; F16M 11/2007; F16M 11/06; H02J 7/0042

(57) ABSTRACT

A holder assembly for portable electronic devices supports tablets, small notebook computers or the like, and allows a user to view the electronic device in a hands-free manner. The assembly includes a holding member having a top surface, a bottom surface and a perimeter edge coupled to and extending between the top and bottom surfaces. The top surface is planar and receives and supports a portable electronic device. An arm is coupled to and extends from the bottom surface of the holding member. A base is coupled to a bottom end of the arm.

### BACKGROUND OF THE DISCLOSURE

### Field of the Disclosure

The disclosure relates to holder assemblies and more particularly pertains to a new holder assembly for supporting portable electronic devices, such as tablets, small notebook computers or the like, and allows a user to view the electronic device in a hands-free manner.

### SUMMARY OF THE DISCLOSURE

An embodiment of the disclosure meets the needs presented above by generally comprising a holding member having a top surface, a bottom surface and a perimeter edge coupled to and extending between the top and bottom surfaces. The top surface is planar and configured for receiving and supporting a portable electronic device. An arm is coupled to and extends from the bottom surface of the holding member. A base is coupled to a bottom end of the arm.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a holder assembly for portable electronic devices according to an embodiment of the disclosure.

FIG. 2 is a side view of an embodiment of the disclosure.

FIG. 3 is a top view of an embodiment of the disclosure.

FIG. 4 is a bottom view of an embodiment of the disclosure.

FIG. 5 is an exploded front view of an embodiment of the disclosure.

FIG. 6 is a side view of an embodiment of the disclosure in use.

### DESCRIPTION OF THE PREFERRED EMBODIMENT

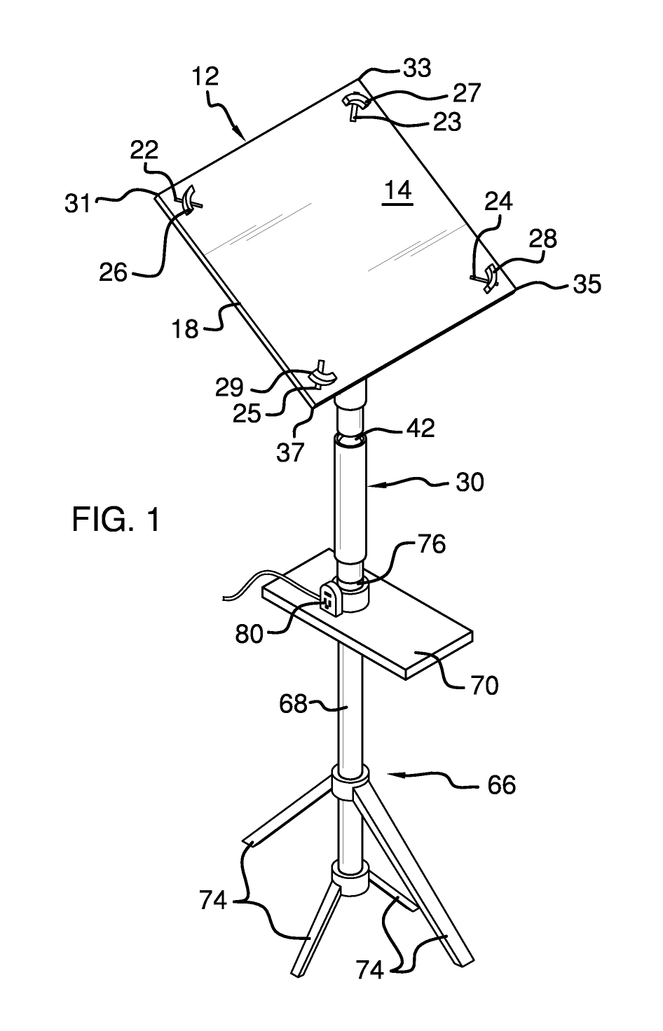

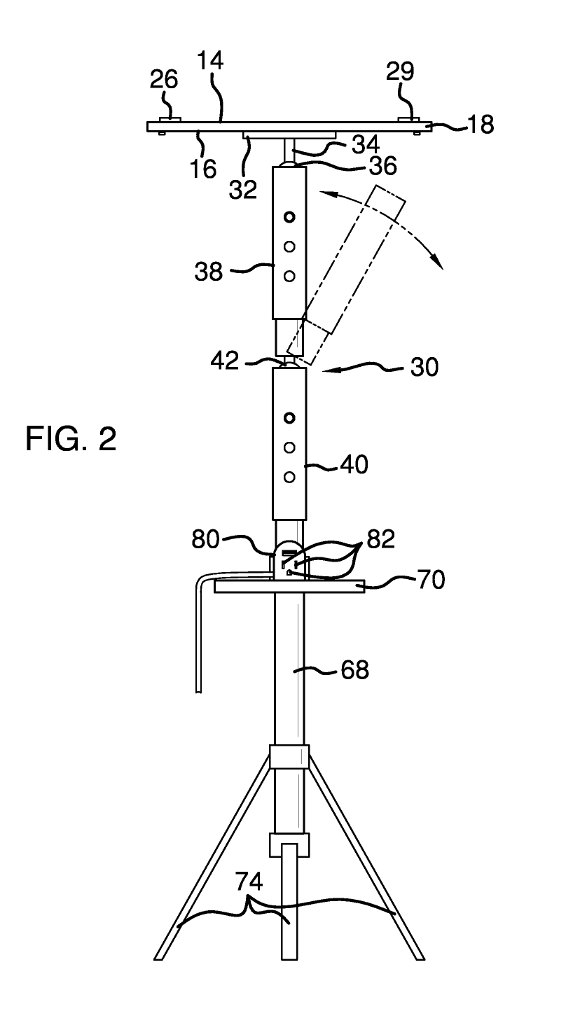

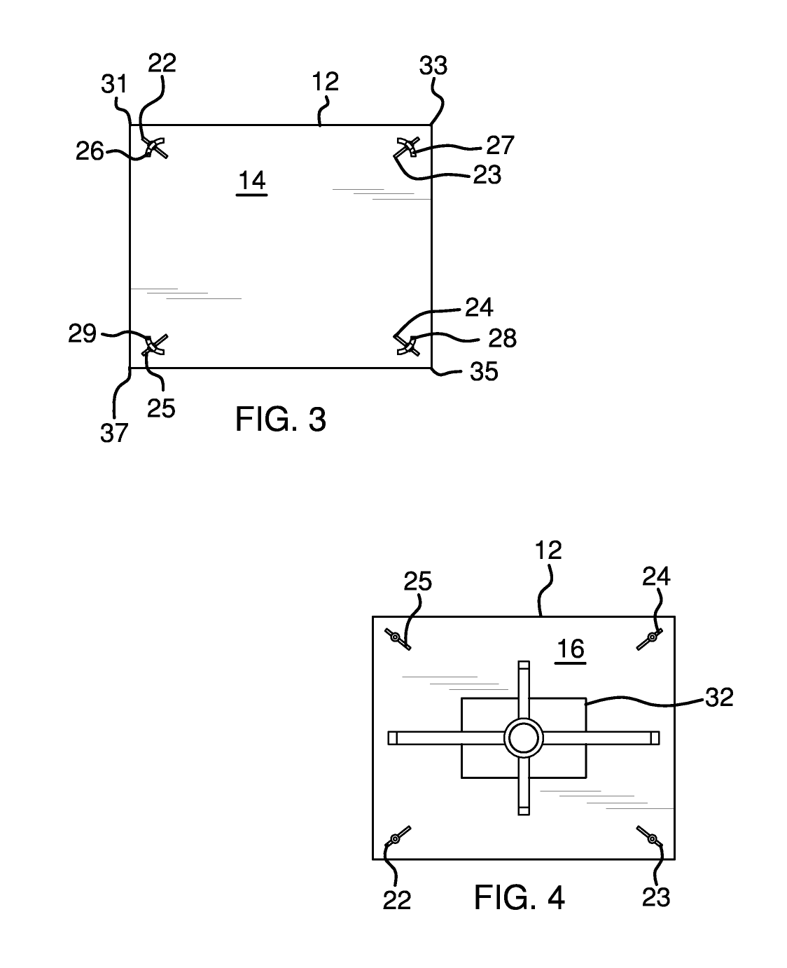

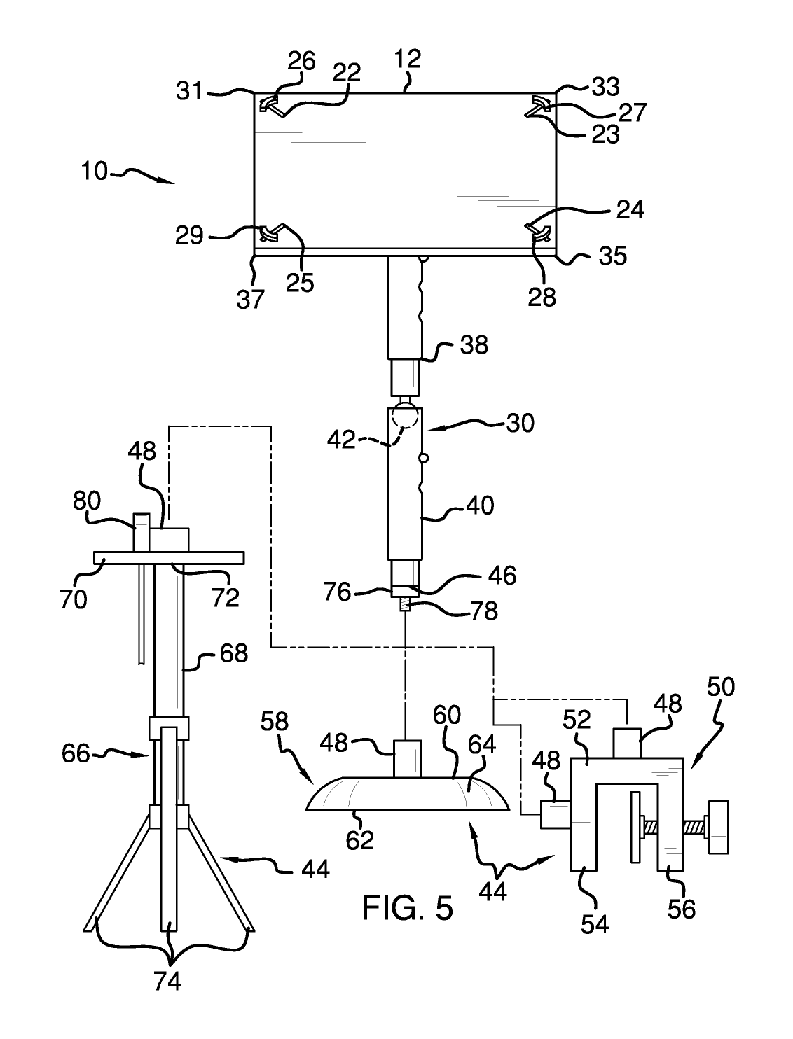

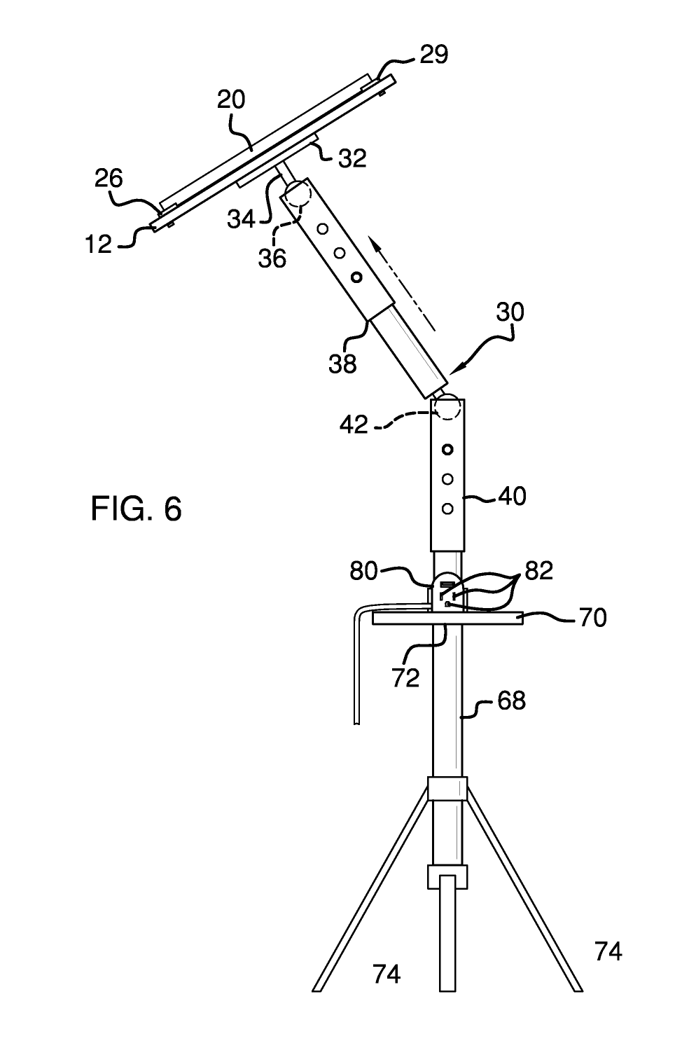

With reference now to the drawings, and in particular to FIGS. 1 through 6 thereof, a new holder assembly embodying the principles and concepts of an embodiment of the disclosure and generally designated by the reference numeral 10 will be described.

As best illustrated in FIGS. 1 through 6, the holder assembly for portable electronic devices 10 generally comprises a holding member 12 having a top surface 14, a bottom surface 16 and a perimeter edge 18 coupled to and extending between the top 14 and bottom 16 surfaces. The top surface 14 is planar and configured for receiving and supporting a portable electronic device 20. The holding member 12 may have a plurality of slots 22, 23, 24, 25 positioned therein each spaced from each other and extending between the top 14 and bottom 16 surfaces of the holding member 12. Each of the slots 22, 23, 24, 25 is positioned adjacent to a respective corner 31, 33, 35, 37 of the holding member 12.

A plurality of grips 26, 27, 28, 29 is coupled to the top surface 14 of the holding member 12 wherein the grips 26, 27, 28, 29 are configured to abut the electronic device 20 and secure the electronic device 20 to the top surface 14 of the holding member 12. The grips 26, 27, 28, 29 may be arcuate and may be comprised of an elastomeric material, such as rubber or the like. Each of the grips 26, 27, 28, 29 is slidably couplable to a respective one of the slots 22, 23, 24, 25 such that each grip 26, 27, 28, 29 is movable within its respective slot 22, 23, 24, 25.

An arm 30, which may be rigid, is coupled to and extends from the bottom surface 16 of the holding member 12. The arm 30 may be positionable at a selectable angle relative to the holding member 12. More particularly, a spacer 32 is coupled to the bottom surface 16 of the holding member 12. A rod 34 is coupled to and extends downwardly from the spacer 32. The rod 34 may be pivotally coupled to the arm 30 through a ball and socket connection 36 or other conventional pivoting means to allow the holding device 12 and the electronic device 20 positioned thereon to be tilted as desired. The arm 30 may be telescopic in a generally conventional manner and may include an upper section 38 and a lower section 40 pivotally coupled together, which may also be done through a ball-and-socket connection 42.

A plurality of bases 44 each is removably couplable to a bottom end 46 of the arm 30 whereby the bases 44 are interchangeably couplable to the arm 30. Each base 44 has at least one socket 48 coupled thereto. The plurality of bases 44 includes a clamp base 50 configured for removably coupling the assembly 10 to a support structure. The clamp base 50 may include a middle section 52 attached to and extending between a pair of arms 54, 56. The socket 48 may be one of a pair of sockets 48 wherein one of the sockets 48 is coupled to the middle section 52 and one of the sockets 48 is coupled to an associated one of the arms 54. 56. This allows the holding device 12 to be positioned either horizontally or vertically relative to the clamp base 50. A stand base 58 is provided having an upper surface 60, a lower surface 62 and a perimeter wall 64 coupled to and extending between the upper 60 and lower 62 surfaces. The stand base 58 may be weighted and may also taper outwardly from the upper surface 60 to the lower surface 62. An elongated base 66 includes a post 68, a panel 70 coupled to a top end 72 of the post 68, and a plurality of legs 74 coupled to and extending outwardly from the post 68. The legs 74 may be telescopically adjustable to vary a height of the holding assembly 12 relative to a ground surface.

The arm 30 may be positionable at a selectable angle relative to the selectable one of the bases 44. In particular, a swivel connection 76 may be coupled to the bottom end 46 of the arm 30 for swivelably coupling the arm 30 to a selectable one of the bases 44. A fastener 78, which may be threaded, is coupled to the bottom end 46 of the arm 30. The fastener 78 is insertable into and engageable with an associated one of the sockets 48 for removably coupling the selectable one of the bases 44 to the arm 30. A charging port 80 is coupled to at least one of the bases 44 and is configured for electrically coupling to the electronic device 20 for recharging the electronic device 20. The charging port 80 may include a plurality of receptacles 82 for receiving male prongs of the electronic device 20.

In use, the arm 30 is attached to the holding member 12 and to a selectable one of the bases 44 as described above. A portable electronic device 20, such as a tablet or the like, is positioned on the top surface 14 of the holding member 12 and is secured thereto by moving the grips 26, 27, 28, 29 within their respective slots 22, 23, 24, 25 until the grips 26, 27, 28, 29 abut the electronic device 20. In this manner, the assembly 10 allows a user to use the electronic device 20 in a hands-free manner. A length of the arm 30 is adjusted as needed and both the arm 30 and holding member 12 can be pivoted into a desired position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A holder assembly for portable electronic devices comprising:
a holding member having a top surface, a bottom surface and a perimeter edge coupled to and extending between said top and bottom surfaces, said top surface being planar and configured for receiving and supporting a portable electronic device;
an arm coupled to and extending from said bottom surface of said holding member; and
a base coupled to a bottom end of said arm.

2. The assembly of claim 1, further comprising wherein said arm is telescopic.

3. The assembly of claim 1, further comprising a plurality of grips coupled to said top surface of said holding member wherein said grips are configured to abut the electronic device and secure the electronic device to said top surface of said holding member.

4. The assembly of claim 3, further comprising each said grip being comprised of an elastomeric material.

5. The assembly of claim 3, further comprising wherein each of said grips is arcuate.

6. The assembly of claim 3, further comprising said holding member having a plurality of slots positioned therein each spaced from each other and extending between said top and bottom surfaces of said holding member, each of said slots being positioned adjacent to a respective corner of said holding member, each of said grips being slidably couplable to a respective one of said slots such that each said grip is movable within said respective slot.

7. The assembly of claim 1, further comprising wherein said base is removably coupled to said bottom end of said arm.

8. The assembly of claim 7, further comprising:
said base having a socket coupled thereto; and
a fastener coupled to said bottom end of said arm, said fastener being insertable into and engageable with said socket for removably coupling said base to said arm.

9. The assembly of claim 1, further comprising said arm being positionable at a selectable angle relative to said base.

10. The assembly of claim 9, further comprising a swivel connection coupled to said bottom end of said arm for swivelably coupling said arm to said base.

11. The assembly of claim 1, further comprising said arm being positionable at a selectable angle relative to said holding member.

12. The assembly of claim 11, further comprising said arm having an upper section and a lower section pivotally coupled together.

13. The assembly of claim 11, further comprising:
a spacer coupled to said bottom surface of said holding member; and
a rod coupled to and extending downwardly from said spacer.

14. The assembly of claim 13, further comprising said rod being pivotally coupled to said arm.

15. The assembly of claim 1, further comprising a charging port coupled to said base, said charging port being configured for electrically coupling to the electronic device for recharging the electronic device.

16. The assembly of claim 1, further comprising wherein said base comprises a clamp base configured for removably coupling said assembly to a support structure.

17. The assembly of claim 16, further comprising said clamp base including a middle section attached to and extending between a pair of arms, said socket being one of a pair of said sockets, one of said sockets being coupled to said middle section, one of said sockets being coupled to an associated one of said arms.

18. The assembly of claim 1, further comprising wherein said base is weighted.

19. The assembly of claim 1, further comprising wherein said base comprises an elongated base, said elongated base including a post and a plurality of legs coupled to and extending outwardly from said post.

20. A holder assembly for portable electronic devices comprising:
a holding member having a top surface, a bottom surface and a perimeter edge coupled to and extending between said top and bottom surfaces, said top surface being planar and configured for receiving and supporting a portable electronic device, said holding member having a plurality of slots each spaced from each other and extending between said top and bottom surfaces of said holding member, each of said slots being positioned adjacent to a respective corner of said holding member;
a plurality of grips coupled to said top surface of said holding member wherein said grips are configured to abut the electronic device and secure the electronic device to said top surface of said holding member, each said grip being comprised of an elastomeric material, each of said grips being arcuate, each of said grips being slidably couplable to a respective one of said slots such that each said grip is movable within said respective slot;
a spacer coupled to said bottom surface of said holding member;
a rod coupled to and extending downwardly from said spacer;
an arm coupled to and extending from said bottom surface of said holding member, said arm being telescopic, said arm being positionable at a selectable angle relative to said holding member, said arm having an upper section and a lower section pivotally coupled together, said rod being pivotally coupled to said arm;
a plurality of bases each being removably couplable to a bottom end of said arm whereby said bases are interchangeably couplable to said arm, each said base having a socket coupled thereto, said arm being positionable at a selectable angle relative to a selectable one of said bases, said plurality of bases including;
a clamp base configured for removably coupling said assembly to a support structure;
a stand base having an upper surface, a lower surface and a perimeter wall coupled to and extending between said upper and lower surfaces, said stand base tapering outwardly from said upper surface to said lower surface, said stand base being weighted; and
an elongated base including a post and a plurality of legs coupled to and extending outwardly from said post;
a swivel connection coupled to said bottom end of said arm for swivelably coupling said arm to said selectable one of said bases;
a fastener coupled to said bottom end of said arm, said fastener being insertable into and engageable with an associated one of said sockets for removably coupling said selectable one of said bases to said arm; and
a charging port coupled to at least one of said bases, said charging port being configured for electrically coupling to the electronic device for recharging the electronic device.
